(19) United States
(12) Patent Application Publication
(10) Pub. No.: US 2004/0234629 A1
(43) Pub. Date: Nov. 25, 2004

(54) Method of decreasing a sessile bivalve population

(75) Inventor: Hiroyuki Nakazato, Tokyo (JP)

Correspondence Address: FOLEY AND LARDNER, SUITE 500, 3000 K STREET NW, WASHINGTON, DC, 20007, US

(73) Assignee: Top Ecology International Corporation

(21) Appl. No.: 10/798,893

(22) Filed: Mar. 12, 2004

Related U.S. Application Data
(60) Provisional application No. 60/454,337, filed on Mar. 14, 2003.

(51) Int. Cl. A01N 65/00

(52) U.S. Cl. 424/750; 424/756; 424/773; 424/770

(57) ABSTRACT

The present invention provides a method for decreasing a sessile bivalve population in a body of water or a water conduit, comprising directing water containing sessile bivalve eggs, larvae, and/or mussels through one or more channels comprising one or more hydrophytes. Channels may be installed in front of a water supply pipe in order to decrease sessile bivalve infestation of the supply pipe.

### BACKGROUND OF THE INVENTION

Infestation of the world's lakes and waterways by sessile bivalves is increasingly becoming more prevalent and more problematic. For example, Dreissena infestation has plagued lakes and waterways in Europe for many years. Two types of Dreissena are the zebra mussel (Dreissena polymorpha) and the quagga mussel (Dreissena bugensis). Recently the invasion of these mussels has spread to North America. Native to an area in the Ukraine and Russia near the Black and Caspian Seas, zebra mussels and quagga mussels spread throughout Eastern Europe in the late 1700's. By 1830, the mussels had spread to lakes and waterways throughout Europe and had invaded Britain. Zebra and quagga mussels are thought to have arrived in North America when one or more transoceanic ships discharged ballast water containing larvae and possibly juvenile zebra and/or quagga mussels into bodies of water in North America. Zebra mussels were first discovered in Lakes St. Clair and Erie in 1988, and have since been found in all of the Great Lakes and in waterways in 19 states and two provinces. Quagga mussels were discovered in 1991 in North America and have since been found in the St. Lawrence Seaway, Lake Ontario, Lake Erie and Saginaw Bay in Lake Huron.

Limnoperna fortunei are sessile bivalves that have life cycles, characteristics and ecologies that are very similar to those of Dreissena. Limnoperna fortunei have been found in Hong Kong, Korea, Taiwan, Japan, and most recently, South America. These mussels were introduced into the Rio de la Plata estuary (Argentina) in 1991, most likely by the discharge of planktonic larvae with ship ballast water.

Sessile bivalve infestation can cause numerous adverse effects. Sessile bivalves are notorious for colonizing water supply pipes of hydroelectric and nuclear power plants, public water supply plants, and industrial facilities, as these creatures have a proclivity for hard or semi-hard surfaces located at moderate depths, such as water intake structures. The mussels colonize pipes constricting flow, therefore reducing the intake in heat exchangers, condensers, fire fighting equipment and air conditions and cooling systems. For example, zebra mussel densities were found to be as high as 700,000 per m² at one power plant in Michigan. In some water treatment facilities, the diameters of pipes have been reduced by two-thirds as a result of zebra mussel infestation. Additionally, Limnoperna fortunei densities were found to be as dense as 80,000 per m² in coastal areas of the Rio de la Plata estuary. Limnoperna fortunei develops populations density at a range between 40,000 and 320,000 specimens per m². Although there is little information sessile bivalves affecting irrigation, farms and golf courses could be likely candidates for infestations

Sessile bivalve infestation can also have a negative impact on native mussels. For example, zebra mussels anchor themselves by the thousands to native mussels making it impossible for native mussels to function. Nearly all of the native mussels in Lake St. Clair and the western basin of Lake Erie have disappeared due to zebra mussel infestation.

Another ill consequence of sessile bivalve infestation is disruption of the eco-system which could ultimately lead to a long-term negative impact on fisheries. Sessile bivalves may remove nearly all particulate matter to which they have access, including phytoplankton and some small forms of zooplankton, causing a competition for phytoplankton, the base of the food web.

Current methods for controlling a sessile bivalve population include chemical molluscicides, manual removal, dewatering/desiccation, steam injection, acoustical vibration, electrical current, filters, screens, toxic constructed piping, CO₂ injection, ultraviolet light, anoxia/hypoxia, and flushing. None of these methods have been shown to accomplish the goal of controlling zebra mussel infestation.

Not only are many of these methods unsuccessful at controlling sessile bivalve population, but also some of these methods themselves can cause a negative impact. For example, a drawback to using a chlorine molluscicide is that the combination of chlorine and organic matter can generate cancer-causing substances such as chloroform and other halogenated hydrocarbons. In addition, chemical toxicants for lake-wide control of zebra mussels are likely to be deadly to other aquatic life forms.

Accordingly, there is a need in the art for successful methods of decreasing a sessile bivalve population in bodies of water and water supply pipes, and especially water which is circulated through purification systems. A suitable method would be non-toxic and inexpensive to operate. Ideally, it could eliminate 95-100% of the sessile bivalves.

### SUMMARY OF THE INVENTION

The present invention provides a method for decreasing the population of a sessile bivalve in a body of water or a water conduit, comprising directing water containing sessile bivalve eggs, larvae, and/or mussels through one or more channels comprising one or more hydrophytes. In some embodiments, sessile bivalve infestation of a water conduit, such as a water intake structure, is decreased or prevented by directing water to flow through one or more channels comprising one or more hydrophytes prior to the water flowing through said structure. In some embodiments, the sessile bivalve is selected from Dreissena, such as Dreissena polymorpha (zebra mussel) and Dreissena bugensis (quagga mussel), and Limnoperna, such as Limnoperna fortunei and Limnoperna siamensis,

### BRIEF DESCRIPTION OF THE DRAWINGS

FIG. 1. Shows hydrophytes growing in channel and formation of root mat.

FIG. 2A-C. (A) Shows contaminated water being pumped from a body of water through channels comprising hydrophytes and treated water flowing back to the body of water. (B) Shows a lengthwise view of a channel; (C) Shows a widthwise view of a channel.

FIG. 3A-B.(A) Shows contaminated water flowing naturally from a river or tributary through the channels. (B) Shows a vertical section of the system.

FIG. 4A-B. (A) Shows a longitudinal cross section of a channel designed for use in cold weather climates. (B) Shows a lateral cross section of a channel designed for use in cold weather climates. The water level for non-icing seasons as well as winter is shown.

FIG. 5. Shows an exemplary channel system. Channels a and b: slope is 1.5%, Channels c and d: slope is 1.0%, Channels e and f: slope is 0.5%, Channels g and h: slope is 0.05%; 1 is watercress, 2 is limnophila, 3 is water iris, 4 is watercress, 5 is mint.

### DETAILED DESCRIPTION OF THE INVENTION

Introduction

The present invention provides a method of decreasing the population of a sessile bivalve in a body of water or a water conduit by directing water containing sessile bivalve eggs, larvae, and/or mussels through one or more channels comprising one or more hydrophytes. In some embodiments, sessile bivalve infestation of a water conduit, such as a water intake structure, is decreased or prevented by placing one or more channels comprising hydrophytes in front of a water intake structure and directing water to flow through the channels prior to flowing through the structure.

Sessile bivalves are bivalves that become permanently attached to a hard or semi-hard surface. Bivalves have a laterally compressed body and a shell consisting of two valves, or movable pieces, hinged by an elastic ligament. Sessile bivalves are bivalves that become permanently attached to a hard or semi-hard surface. The term “sessile bivalve” includes, but is not limited to Dreissena, such as Dreissena polymorpha (zebra mussel) and Dreissena bugensis (quagga mussel), and Limnoperna, such as Limnoperna fortunei and Limnoperna siamensis. In some embodiments, the sessile bivalve is a non-indigenous sessile bivalve.

The term “body of water” is used to mean a lake, river, stream, tributary, marsh, dam, reservoir, or other water source. The body of water may be fresh water or salt water. A salt concentration up to about 1% is well tolerated by the present system. Higher concentrations can be tolerated in some cases or, alternatively, fresh water can be used to dilute the input stream.

Infestation of bodies of water by a sessile bivalve can have numerous ill effects. Sessile bivalves produce many eggs. For example, mature zebra mussel females can produce up to 30,000 to 1,000,000 eggs per year. After the eggs hatch, a free-swimming veliger larva feeds on plankton and grows for about 10 to 14 days. When the sessile bivalve veliger larvae hit any solid or semi-solid matter, they extend thread-like legs containing sticky protein fibers. Once the veliger larvae attach to solid or semi-solid matter, they remain attached for the rest of their life cycle. As a result, populations of sessile bivalve in a body of water is undesirable because of their propensity to build large colonies and to clog water intake or outtake vessels, such as pipes. As used herein, the terms “larvae”, “veliger larvae” and “veliger” are equivalent in meaning.

The present invention provides an ecologically friendly solution to the problem of sessile bivalve infestation.

The Channels

The channels employed in the present invention are shallow and wide waterways. Any channel in which a hydrophyte can grow is suitable for the present invention. The channel may be constructed of any material that prevents water permeation or destruction by plant roots. Exemplary materials are concrete, plastic, compacted clay, asphalt, rubber, and metal. Soil hardening methods that are well known to those of skill in the art may be used to construct a channel out of soil.

Generally, each channel will be about 1 to about 10 meters wide and about 10 to about 20 meters long. Preferably, the channel is about 15 to 20 meters long. More preferably, the channel is 18 to 20 meters long. In some embodiments, the channel will be inclined from about 0.5% to about 1.5%. Preferably, the slope of the channel is 1%.

In some embodiments, such as embodiments in which the method is performed in a climate in which surface water rarely freezes, the depth of the water in the channel may be about 2 to 15 cm. In other embodiments, such as embodiments in which the method is performed in a climate in which surface water freezes, the depth of the water in the channel may be 40 to 60 cm, including the depth of the frozen water surface. The water flowing beneath the ice allows the hydrophytes to live and function in cold weather.

The channels are designed so that water may flow through the channels. Generally, water flows through the channels at a standard flow rate of about 0.2 m/minute to about 3 m/minute. In preferred embodiments, water flows through the channel at a flow rate of 1 m/minute. In some embodiments, the water flow is controlled naturally, such as by directing the flow of stream water. In other embodiments, the water flow rate is controlled by a device that is capable of controlling the flow of water through the channels. Exemplary devices are water pumps, dams, and barrages. In some embodiments, these devices are replaced periodically if they become contaminated. Ideally, the system is designed so that water naturally flows through the channels before it is introduced into mechanical devices.

The channels may be positioned in any configuration to achieve a decrease in a sessile bivalve population. One or more channels may be employed. In preferred embodiments, several channels are installed in parallel. The number of channels in the system depends on the amount of water that is to be purified and can easily be determined by a person of ordinary skill in the art.

In some embodiments, the channels are installed in the ground. In other embodiments, the channels are attached to one or more floats. Any float on which a channel can be positioned according to the present invention is within the scope of the present invention. An exemplary float comprises a polystyrene foam block (specific gravity of 0.002) that is coated by polyurethane of about 2 mm thick (specific gravity 1.0). The size and configuration of the float can be easily determined by those of ordinary skill in the art according to the weight and weight distribution of the channel that is to be positioned on the float. In some embodiments, one or more channels may be positioned on another structure, such as the roof of a building.

The Hydrophytes

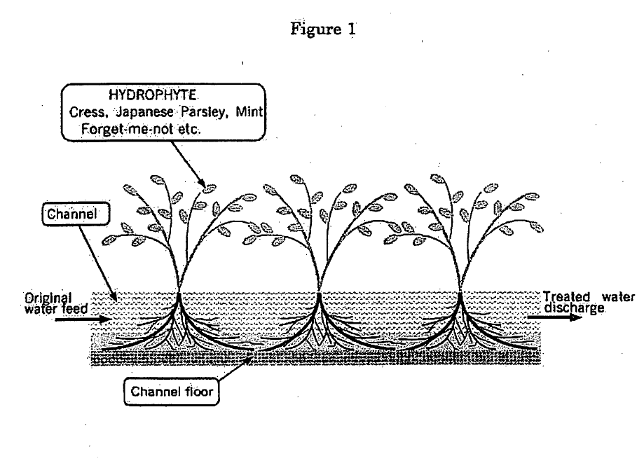

The present invention involves flowing water through one or more channels comprising one or more hydrophytes. The term “hydrophyte” is used herein to mean a plant that grows partly or wholly in water whether rooted in mud or floating without anchorage. The root system of hydrophytes growing in the channels serves as a root mat to form a three-dimensional mesh filter. See FIG. 1. Preferably, the depth of the root mat is about 1 to about 10 cm. The system will generally deposit detritus on the floor of the channels.

The root mat density causes sessile bivalve eggs and veliger larvae to be filtered and caught in the root mat and biofilm which is formed around the roots. Newly settled veliger larvae resembling adult sessile bivalves yet smaller in size, as well as adult mussels, are also caught in the root mat and biofilm. The root mat, with its biofilm, provides a suitable inhabiting environment for microorganisms and small organisms, including but not limited to vorticella, stentor, physa acuta, conch, wormfish, bloodsuckers, demersal fish, demersal fish juvenile, shrimp, Rotifera, Ciliata, Rotatoria, Bdelloida, Branchiopoda, Copepoda, Decapoda, Oligochaeta, Gastropoda, Decapoda, Hirudinea, Cobitidae, Channidae, Gobiinae, and Annelida. One or more of these organisms inhabiting the root mat may prey on sessile bivalve eggs, larvae and/or mussels. For example, it has been shown that 1 gram of water cress root mat may hold over 20,000 microorganisms, such as vorticella and/or stentor. In other cases, it has been shown that over 60,000 physa acuta and over 6,000 bloodsuckers may be found in water cress root mat per one square meter.

Typically, predators of sessile bivalve eggs and/or veligers which may inhabit the root mat include, but are not limited to, species from the phylum, class, subclass or order selected from the group consisting of Ciliophora, Spirotricha, Peritricha, Rotatoria, Collothecacea, Ploima, Bdelloida, Crustacea, Branchiopoda, Cladocera, Ostracoda, Copepoda, and Eucopepada. Predators of sessile bivalve eggs and/or veligers which may inhabit the root mat typically include but are not limited to species selected from the group consisting of Ciliata, Spivostomum, ambiguum, Stentor polymorphus, Bursaria truncatella, Trichodina pediculus, Vorticella nebulifera, Carchesium polypinum, Zoothamnium arbuscula, Lagenophrys ampulla, Collotheca cornuta, Floscularia, Conochilus hippocrepis, Conochilus unicornis, Floscularia ringens, Notommata aurita, Synchaeta stylata, Synchaeta tremula, Ploeosoma truncatum, Polyarthra trigla, Filinia longiseta, Sida crystallina, Diaphanosoma brachyuruma, Holopendium gibberum, Daphnia pulex, Daphnia longispina, Simocephalus vetulus, Ceriodaphnia quadrangula, Moina macrocopa, Bosmina longirostris, Bosminopsis deitersi, Alona quadrangularis, Graptoleberis testudinaria, Cydorus sphaericus, Polyphemus pediculus, and Leptodora kindtii. Typically, predators of sessile bivalve larvae and/or attached larvae (up to 1 mm in size) which may inhabit the root mat include, but are not limited to, species from the phylum, class, subclass or order selected from the group consisting of Decapoda, Annelida, Oligochaeta, Gastropoda, Prosobranchia and Pulmonata. Predators of sessile larvae and attached larvae which may inhabit the root mat typically include but are not limited to species selected from the group consisting of Macrura, Neocaridina denticulata, Paratya compressa improvisa, Leander paucidens, Aeolosomatidae, Naididae, Tubificidae, Lumbriculidae, Haplotaxidae, Criodrilidae, Branchiobdellidae, Bulimus striatulus japonicus, Physa acuta, Assiminea japonica, Lymnaea Japonica, Lymnaea pervia, and Gyraulus hiemantium. Typically, predators of sessile bivalve mussels which may inhabit the root mat include, but are not limited to, species from the phylum, class, subclass or order selected from the group consisting of Hirudinea, Rhynchobdellida, and Gnathobdellida. Predators of sessile bivalve mussels which may inhabit the root mat typically include but are not limited to species selected from the group consisting of Cambaroides japonicus, Procambarus clarkii, Piscicola sp., Helobdella stagnalis, Hemiclepsis kasmiana, Glossiphonia lata, Glossiphonia complanata, Orobdella whitmani, Herpobdella lineata, Whitmania pigra, Hirudo nipponia, Cobitidae, Channidae, and Gobiinae. In some embodiments, some of the predators eat any or all of sessile bivalve eggs, larvae and mussels.

In some embodiments, the organisms that live in the root mat and prey on the sessile bivalve eggs, larvae and/or mussels crawl into water conduits housing sessile bivalves and eat the sessile bivalves. One or more organisms that prey on sessile bivalve eggs, larvae and/or mussels may be added to the channels to prey on the sessile bivalve eggs and larvae that are caught in the root mat The channels comprising one or more hydrophytes provide an environment for establishing an ecosystem in which the sessile bivalve that is to be eliminated is part of the food chain. Some species of fish and diving ducks may also prey on the sessile bivalves.

It is desirable in some cases to replace the root mat system from time to time. Sessile bivalve eggs, larvae and mussels are eliminated upon removal of the remnants after water is drained from the channel. Exemplary remnants are soil, plant roots and stems. Remnant removal is preferably performed in cold weather when sessile bivalve veliger larvae do not appear. For example, Dreissena veligers do not appear when the water temperature is below about 12° C. (53° F.). Additionally, Limnoperna fortunei spawn at temperatures of 16-28° C. After the water supply to the channels is stopped, the remnants on the channel floor are dried, for example by solar heat. Any sessile bivalve eggs, larvae and mussels that were trapped in the channels die. The remnants may be used as compost.

Any hydrophyte that is capable of forming a root mat is suitable for the present invention. Exemplary hydrophytes are cress, such as watercress (Rorippa microphylla), Japanese parsley(Cryptotaenia japonica), morning glory (Ipomoea purpurea), water chestnut (Trapa natans), taro (Colocasia esculenta), calla (Zantedeschia aethiopica), forget-me-not (Myosotis sylvatica), Luisiana iris (Iris giganticaerulea), Pickerel weed (Pontederia cordata), mint(Mentha piperata), water feather (Myriophyllum aquaticum), Dropwort (Filipendula vulgaris), Pak-Bung (Ipomoia aquatica Forsk), swamp cabbage(Ipomoea aquatica), water spinach, aquatic morning glory, swamp cabbage, ung-choi, kang kong (Ipomoea aquatica), wild rice (Zizania latifolia), Limnophila (Limnophila aromatica), Edible Jute (Corchorus olitorius), Cucharita-parrot leaf (Alternanthera ficoidea), Taro (Colocasia esculenta), Screw pine (Pandanusu odorus), Creeping jenny (Lysimachia nummularia), Zebra rush (Scirpus tabernaemontani), Dwarf cattail (Typha minima), Water hyssop (Bacopa monnieri), Water Irises (Iris s.p.), Ophiopogon (Ophiopogon japonicus), Acorus gramineus (Acorus gramineus), Acorus calamus (Acorus calamus), Canna (Canna americanallis), Melon sword (Echinodorus radican), Bluebell (Ruellia squarrosa), Arrowhead (Sagittaria s.p.), Water poppy (Hydrocleys nymphoides), Water lettuce (Pistia stratiotes), Water hyacinth (Eichhorinia crassipes), Water pennywort (Hydrocotyle), Heliconia (Heliconia s.p.), Parrot feather (Myriophyllum brasiliense), Red Bacopa (Bacopa caroliniana), Giant Bacopa (Bacopa lanigera), star grass (Dichromena colorata), umbrella palm (Cyperus alternifolius), and dwarf papyrus (Cyperus haspan). In preferred embodiments, the channel comprises one or more hydrophytes that abandon their roots after two to three months of growth, such as cress, Japanese parsley, dropwort, morning glory, pak-bung, swamp cabbage, water spinach, taro, calla, forget-me-not, mint, water feather, star grass, umbrella palm, and dwarf papyrus. One especially preferred hydrophyte is watercress. Evergreen herbaceous perennials such as Forget-me-not (Myosotis Sylvatica), Louisiana Iris (Iris giganticaerulea) mint (mentha piperata), acorus grumineus, and watercress (Rorippa microphylla), preferably watercress, are also desirable so that year-round water purification is possible.

Methods of Use

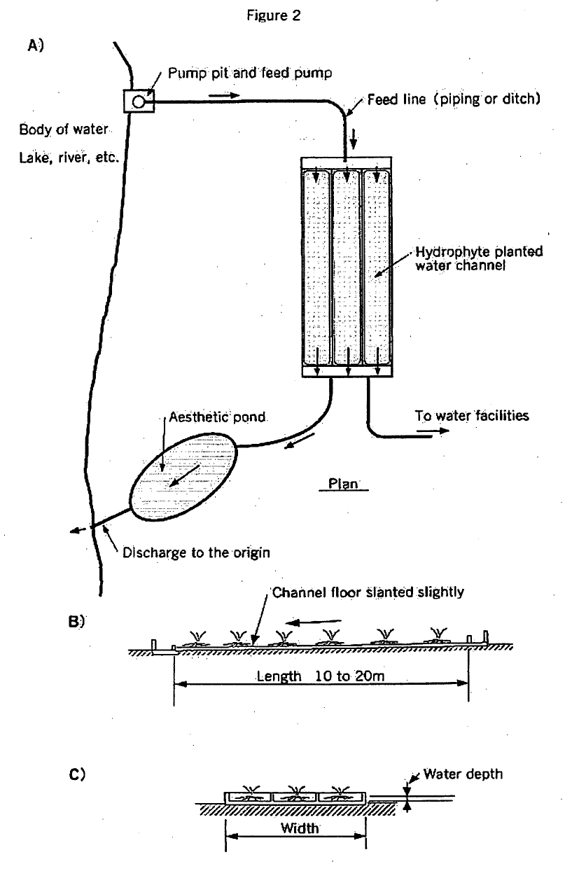

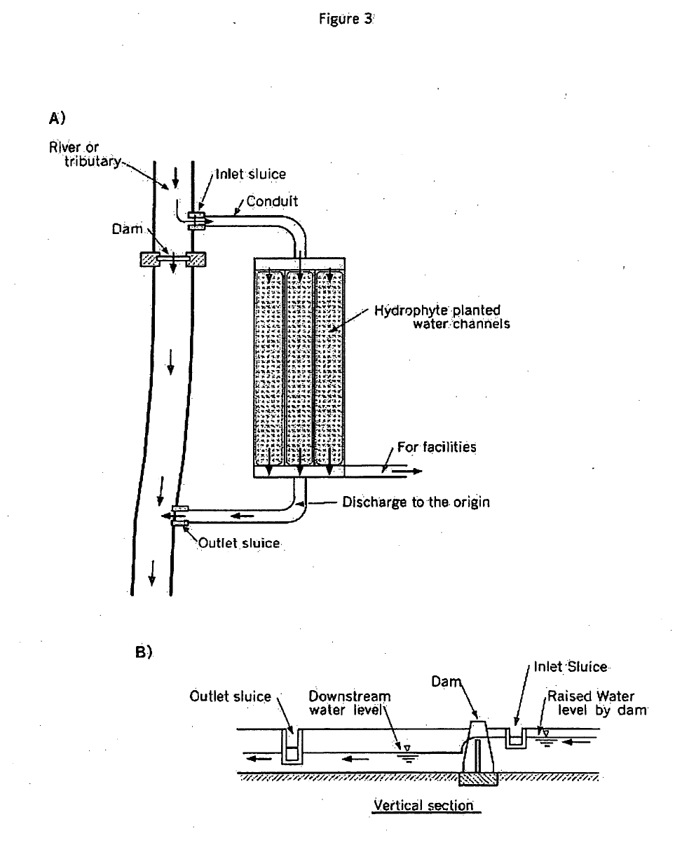

A general depiction of the present invention is provided in FIG. 2. Water containing sessile bivalve egg, larvae, and/or mussels is removed from the sessile bivalve-infested body of water and directed toward channels comprising hydrophytes. The water flows through the channels so that sessile bivalve eggs, larvae, and/or mussels are filtered and caught in the hydrophyte root mat. The treated water is then returned to the body of water. The sessile bivalve infested water may be mechanically pumped to the channels, as shown in FIG. 2. Alternatively, the sessile bivalve infested water may flow naturally through the channels, as shown in FIG. 3.

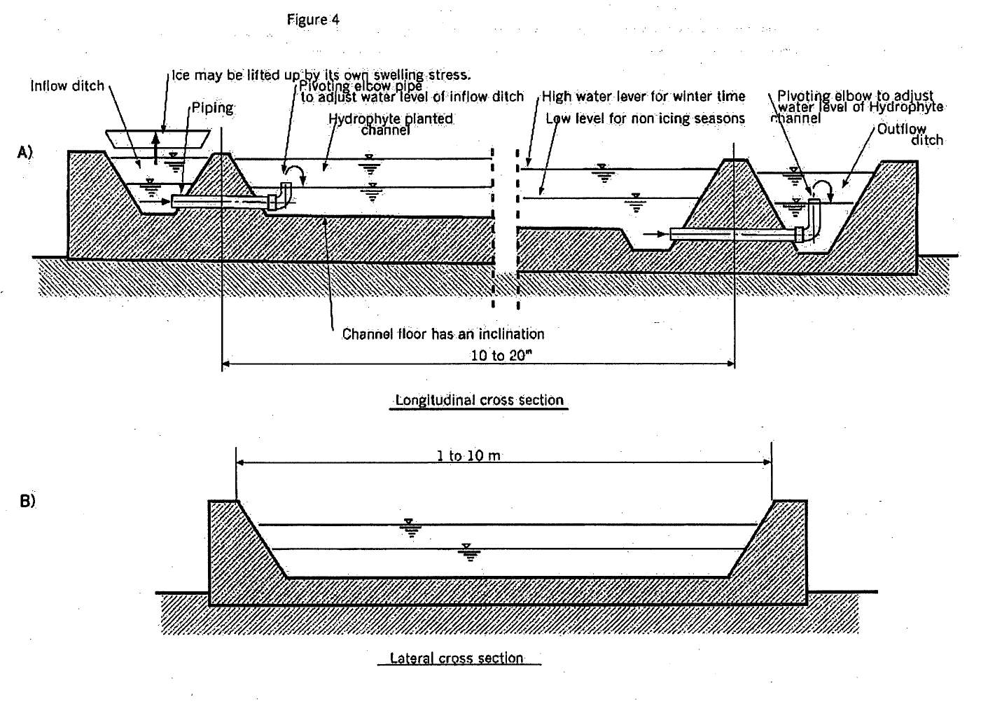

The present method can be employed in warm or cold weather climates. In warm weather climates, the depth of the water in the channel is about 2 cm to about 15 cm. In cold weather climates, where surface water is frozen all or part of the year, the depth of the water in the channel may be 40 to 60 cm, including the depth of the frozen water surface. An exemplary system for cold weather climates is shown in FIG. 4. The system is equipped with a pipe leading from the inflow to the channel and from the channel leading to the outflow. During times when the weather is warm, the water supply is controlled on the shallower end of the channel (inflow side). However, during times when the weather is cold, the water supply is controlled on the deeper end of the channel (outflow side). The sides of the channel may be sloped to release icing pressure outward.

In some embodiments, such as when the method is employed in extreme winter conditions (i.e., when ice forms all the way down to the root mat), the water can be emptied from the channels and the plants removed until the following spring. For example, Dreissena larvae do not appear in bodies of water where the water temperature is below about 12° C. (53° F.). In fact, in U.S. lakes and rivers that are located in a cold climate zone, Dreissena larvae have been known to reproduce only between about the months of May and October. Therefore, in embodiments involving decreasing the population of Dreissena in a body of water, in extreme winter conditions, the water can be emptied from the channels and the plants removed until the following spring.

In some embodiments, the present invention is used to decrease or prevent sessile bivalve infestation of a water conduit. Exemplary water conduits are water intake structures, such as those used for power plants, factories and municipal water treatment plants, as well as agricultural irrigation pipes and fresh water aquaculture. The structure may be a pipe or other structure through which water can flow. In such embodiments, one or more channels comprising hydrophytes are placed in front of a water intake structure and water is directed to flow through the channels prior to flowing through the structure.

The present,invention achieves high rates of elimination of a sessile bivalve population from a body of water, preferably, 90-100% elimination, more preferably 95-100% elimination, and most preferably, virtually 100% elimination. While it should not be necessary to add chemicals to the treated water in order to decrease a sessile bivalve population, in some embodiments of the present invention, chemicals, preferably in non-toxic amounts, may be added to the water after the water flows through the channels and before the water is returned to the body of water or allowed to flow through a water supply pipe. A person of skill in the art is familiar with chemicals that kill sessile bivalve eggs, larvae, and/or mussels. For example, 0.1 mg/liter-0.5 mg/liter chlorine and/or bromine may be added to the water after the water has flowed through the channel.

### EXAMPLES

### Example 1

### Decreasing Limnoperna fortunei Population

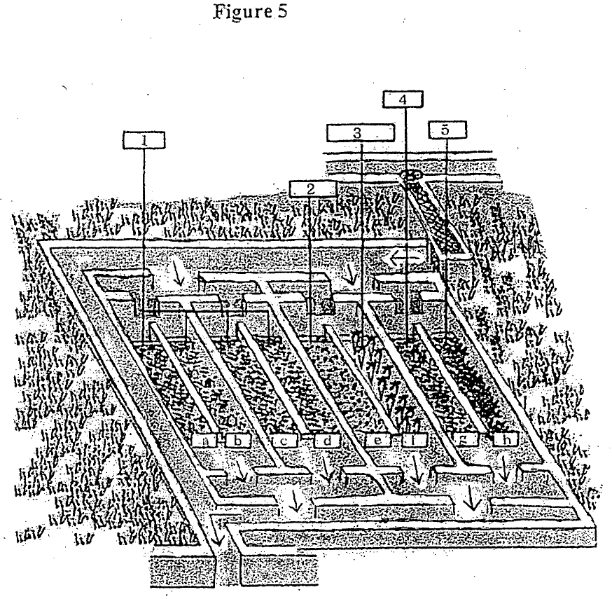

Eight channels are installed in parallel in front of a water intake pipe. The channels are constructed of concrete and are 20 meters long and 2.5 meters wide. The depth of the water in the channels is between 2-15 cm. The system is carried out at four different slopes (1.5%, 1%, 0.5% and 0.05%). As shown in FIG. 5, the slopes of channels a and b are 1.5%, the slopes of channels c and d are 1.0%, the slopes of channels e and f are 0.5% and the slopes of channels g and h are 0.05%. Planted along the first 15 meters of the channels are the following hydrophytes: watercress in channels a, b, c, d, and g; mint in channel h; water irises in channel f, and limnophila in channel e hydrophytes. The roots of these hydrophytes form a root mat that is about 2-10 cm deep. Water from a body of water containing Limnoperna fortunei eggs, larvae, and/or mussels flows through the channels at a standard flow rate of about 1 m/minute. When the nitrogen and phosphorus levels in the intake water are low, seeding of Physa acuta is also performed.

Prior to installing the system, many Limnoperna fortunei are found in the water. However, after treatment with the system, no Limnoperna fortunei are found in the treated water and the water area around the treated water outlet. Limnoperna fortunei are virtually completely removed from the water prior to the water flowing through the water intake pipe.

### Example 2

### Decreasing Zebra Mussel Infestation of Water Intake Pipe

Four channels are installed in parallel in front of a water intake pipe. The channels, constructed of concrete, are 20 m long, 5 meters wide and sloped 1%. The depth of the water in the channel is between 2-15 cm. Planted in the channel are watercress and other hydrophytes. The roots of these hydrophytes form a root mat that is about 5 cm deep. Water from a body of water containing zebra mussel eggs, larvae, and/or mussels flows through the channels at a standard flow rate of about 1 m/minute. The treated water then flows through the water intake pipe. 95-100% of the zebra mussel eggs, larvae, and/or mussels are removed from the water prior to the water flowing through the pipe.

It will be apparent to those skilled in the art that various modifications and variations can be made to the compositions and processes of this invention. Thus, it is intended that the present invention cover such modifications and variations, provided they come within the scope of the appended claims and their equivalents.

We claim:

1. A method for decreasing a sessile bivalve population in a body of water or a water conduit, comprising directing water containing sessile bivalve eggs, larvae, and/or mussels through one or more channels comprising one or more hydrophytes.

2. The method of claim 1, wherein said sessile bivalve is selected from the group consisting of Dreissena polymorpha, Dreissena bugensis, Limnoperna fortunei, and Limnoperna siamensis.

3. The method of claim 1, wherein said hydrophyte is selected from the group consisting of cress, Japanese parsley, morning glory, aquatic morning glory, water chestnut, taro, calla, forget-me-not, Luisiana iris, pontederia, Pickerel weed, mint, water feather, Dropwort, Loosetrife, Pak-Bung, swamp cabbage, water spinach, wildrice, Limnophila, Edible Jute, Cucharita-parrot leaf, Taro, Screw pine, Creeping jenny, Loosestrife, Zebra rush, Dwarf cattail, Water hyssop, Water Irises, Ophiopogon, Acorus gramineus, Acorus calamus, Canna, Melon sword, Bluebell, Arrowhead, Water poppy, Water lettuce, Water hyacinth, Water pennywort, Heliconia, Parrot feather, Red Bacopa, Giant Bacopa, star grass, umbrella palm, and dwarf papyrus.

4. The method of claim 1, wherein said hydrophyte is watercress.

5. The method of claim 1, wherein said channel is about 10 to about 20 meters long.

6. The method of claim 1, wherein water flows through said channel at a flow rate of about 0.2 m/minute to about 3 m/minute.

7. The method of claim 1, wherein said channel is installed in the ground.

8. The method of claim 1, wherein said channel is attached to a float.

9. The method of claim 1, wherein said channel is about 1 to about 10 m wide.

10. The method of claim 1, wherein the water depth in the channel is about 2 cm to about 15 cm.

11. The method of claim 1, wherein said directing is accomplished by a water pump.

12. The method of claim 1, wherein roots of said hydrophyte create a root mat.

13. The method of claim 1, wherein the depth of said root mat is about 1 to about 10 centimeters.

14. The method of claim 1, further comprising adding 0.1 mg/liter to 0.5 mg/L chlorine and/or bromine to said water.

15. The method of claim 1, wherein said body of water is a fresh water body of water.

16. The method of claim 1, wherein said body of water comprises salt at a concentration of 0.6-1%.

17. The method of claim 1, wherein the water depth in the channel is about 40 cm to about 60 cm.

18. The method of claim 1, wherein said channel further comprises an organism from the phylum, class, subclass or order selected from the group consisting of Ciliophora, Spirotricha, Peritricha, Rotatoria, Collothecacea, Ploima, Bdelloida, Crustacea, Branchiopoda, Cladocera, Ostracoda, Copepoda, Eucopepada, Decapoda, Annelida, Oligochaeta, Gastropoda, Prosobranchia, Pulmonata, Hirudinea, Rhynchobdellida, and Gnathobdellida.
